(19) United States
(12) Patent Application Publication
(10) Pub. No.: US 2020/0201654 A1
(43) Pub. Date: Jun. 25, 2020

(54) CONTROL DEVICE FOR MULTI-DRIVER COMPATIBILITY AND IMPLEMENTATION METHOD

(71) Applicant: AUTEL INTELLIGENT TECHNOLOGY CORP., LTD., Shenzhen (CN)

(72) Inventor: Weilin WANG, Shenzhen (CN)

(21) Appl. No.: 16/804,594

(22) Filed: Feb. 28, 2020

Related U.S. Application Data
(63) Continuation of application No. PCT/CN2018/102998, filed on Aug. 29, 2018.

(30) Foreign Application Priority Data
Aug. 30, 2017 (CN) 201710763249.1

(51) Int. Cl. G06F 9/4401; G06F 13/10; G06F 13/42; G06F 8/65; G06F 13/40

(52) U.S. Cl. CPC G06F 9/4411; G06F 13/102; G06F 13/4022; G06F 8/65; G06F 13/4282

(57) ABSTRACT

The present application discloses a control device for multi-driver compatibility and an implementation method. The control device for multi-driver compatibility includes: a memory, a processor and a computer program stored on the memory and executable on the processor, where when executed by the processor, the computer program implements the following steps: obtaining identity information of a connected peripheral component; reading, according to the identity information, configuration information corresponding to the peripheral component pre-stored in a specific storage unit; and loading a corresponding driver according to the configuration information. In the embodiments of the present invention, compatibility with drivers of a plurality of peripheral components is achieved. Flexibility of replacing a component of a product is improved. A problem that a life cycle of a peripheral component is not synchronized with a life cycle of a main module is resolved. In addition, configuration information of a peripheral component is not limited by a hardware condition. Configuration is simple and flexible.

This application is a continuation of International Patent Application No. PCT/CN2018/102998 filed on Aug. 29, 2018, which claims priority to Chinese Patent Application No. 201710763249.1 filed on Aug. 30, 2017, both of which are incorporated by reference herein in their entireties.

### BACKGROUND

### Technical Field

The present application relates to the field of information technologies, and in particular, to a control device for multi-driver compatibility and an implementation method.

### Related Art

A handheld mobile terminal usually includes a main control chip central processing unit (CPU) and components such as a read-only memory (ROM), a dual data rate (DDR) synchronous dynamic random access memory, a liquid crystal display (LCD), a touch panel (TP), a Wireless-Fidelity (WiFi), a Bluetooth (BT), a camera, and a power management unit (PMU). When circuitry and hardware of a handheld mobile terminal are designed, a main control chip CPU and all other components are usually connected through an appropriate bus wire according to a characteristic of the main control chip CPU. After being connected, all the components may be divided into a main module and peripheral components. The main module usually includes a plurality of components such as a CPU, a ROM, a DDR and a PMU, while other components are separate peripheral components. When being completed, the design of the main module will not be changed easily. Otherwise, the entire design solution needs to be changed. However, some peripheral components, such as an LCD, a TP, a WiFi, a BT, a camera, and a battery, are provided by different vendors, have life cycles that are not synchronized with the main module, and may be discontinued or replaced during a life cycle of an entire product.

In the prior art, configuration information of each peripheral component is usually written into the main module in a form of a fixed program. Different peripheral components then are marked and adapted to by using a dial switch technology or a general-purpose input output (GPIO) pin pull-up/pull-down technology, corresponding drivers then being executed, to achieve multi-driver compatibility. Such a design method is limited by a quantity of combination states, can only distinguish simple cases, and cannot clearly distinguish complex cases. If a large number of peripheral components are used, each peripheral component possibly having several types of substitutes, the problems cannot be resolved by using the traditional method.

### SUMMARY

To resolve the foregoing technical problem, the present invention provides a multi-driver compatible device and an implementation method, to enhance compatibility with drivers, and resolve a problem of difficulty in replacing a peripheral component.

To achieve an objective of the present invention, an embodiment of the present invention provides a control device for multi-driver compatibility, including: a memory, a processor and a computer program stored on the memory and executable on the processor, where when executed by the processor, the computer program implements the following steps:

obtaining identity information of a connected peripheral component

reading, according to the identity information, configuration information corresponding to the peripheral component pre-stored in a specific storage unit; and

loading a corresponding driver according to the configuration information.

Optionally, the configuration information includes a number of the peripheral component and corresponding version information.

Optionally, the specific storage unit is a separate storage module, or

a non-erasable area is set in the memory as the specific storage unit.

Optionally, the specific storage unit is an electrically erasable programmable read-only memory EEPROM.

Optionally, when executed by the processor, the computer program implements the following steps:

obtaining the identity information of the peripheral component according to a type of an interface connected to the peripheral component; or

directly obtaining the identity information of the peripheral component preset in the specific storage unit.

Optionally, when executed by the processor, the computer program implements the following steps:

during replacement for a peripheral component of a different version, resetting configuration information and/or identity information of the peripheral component stored in the specific storage unit.

Optionally, when executed by the processor, the computer program implements the following step:

during replacement for a peripheral component of a different version, resetting configuration information and/or identity information of the peripheral component stored in the specific storage unit.

An embodiment of the present invention further provides an implementation method for multi-driver compatibility, applied to a control device for multi-driver compatibility including a processor and a memory, the control device for multi-driver compatibility being connected to one or more peripheral components, the method including:

obtaining identity information of a connected peripheral component;

reading, according to the identity information, configuration information corresponding to the peripheral component pre-stored in a specific storage unit; and

loading a corresponding driver according to the configuration information.

Optionally, the configuration information includes a number of the peripheral component and corresponding version information.

Optionally, the specific storage unit is a separate storage module, or

a non-erasable area is set in the memory as the specific storage unit.

Optionally, the specific storage unit is an electrically erasable programmable read-only memory EEPROM.

Optionally, the step of obtaining identity information of a connected peripheral component includes:

obtaining the identity information of the peripheral component according to a type of an interface connected to the peripheral component; or

directly obtaining the identity information of the peripheral component preset in the specific storage unit.

Optionally, the method further includes:

during replacement for a peripheral component of a different version, resetting configuration information and/or identity information of the peripheral component stored in the specific storage unit.

Optionally, the method further includes:

during replacement for a peripheral component of a different version, resetting configuration information and/or identity information of the peripheral component stored in the specific storage unit.

An embodiments of the present invention further provides a computer-readable storage medium, storing a computer-executable instruction, where the computer-executable instruction is configured to perform the foregoing implementation method for multi-driver compatibility.

Compared with the prior art, the embodiments of the present invention have the following advantages:

1. Compatibility with drivers of a plurality of peripheral components is achieved. Flexibility of replacing a component of a product is improved. A problem that a life cycle of a peripheral component is not synchronized with a life cycle of a main module is resolved.

2. A traditional dial switch occupies a large area of a printed circuit board (PCB), and presents a limited amount of information. If a pin pull-up/pull-down solution, such as GPIO, is adopted, a limited amount of information is presented due to a limitation of a quantity of GPIOs. However, in the embodiments of the present invention, component information and version information configuration are not limited by hardware conditions. Configuration is simple and flexible.

3. Implementation costs are low. Currently, an electrically erasable programmable read-only memory (EEPROM) has low costs, a large storage capacity, and high reliability.

4. If no configuration information corresponding to the peripheral component is read or the configuration information is determined to be wrong, a default driver is loaded, thereby achieving compatibility with a case of no configuration information or wrong configuration information.

Other features and advantages of the present invention are described below in the specification, and will partially be obvious in the specification, or be understood by implementing the present invention. The objective and other advantages of the present invention may be realized or obtained from structures particularly pointed out in the specification, the claims and the accompanying drawings.

### BRIEF DESCRIPTION OF THE DRAWINGS

The accompanying drawings are used to provide a further understanding of the technical solutions of the present invention, constitute a part of the specification, are used, together with the embodiments of the present application, to explain the technical solutions of the present invention, and do not constitute a limitation to the present invention.

FIG. 1 is a schematic diagram of an application environment of a control device for multi-driver compatibility according to an embodiment of the present invention;

FIG. 2 is a schematic diagram of a functional module of a control device for multi-driver compatibility according to an embodiment of the present invention;

FIG. 3 is a schematic diagram of a control device for multi-driver compatibility according to an application example of the present invention;

FIG. 4 is a schematic diagram of a configuration information storage format according to an application example of the present invention;

FIG. 5 is a schematic diagram of version information of a component according to an application example of the present invention;

FIG. 6 is a flowchart of an implementation method for multi-driver compatibility according to an embodiment of the present invention; and

FIG. 7 is a flowchart of an implementation method for multi-driver compatibility according to an application example of the present invention.

### DETAILED DESCRIPTION

To make the objectives, technical solutions, and advantages of the present invention clearer, embodiments of the present invention are described in detail below with reference to the accompanying drawings. It should be noted that, provided that no conflict is caused, the embodiments in the present application or the features in the embodiments may be combined together arbitrarily.

The steps shown in the flowcharts in the accompanying drawings may be executed in, for example, a computer system such as a set of computer-executable instructions. In addition, although a logical order is given in the flowcharts, in some cases, the shown or described steps may be executed in an order different from the order shown herein.

This embodiment provides driver loading based on configuration information, a driver supporting a plurality of hardware versions. A corresponding driver is loaded according to configuration information of a peripheral component, to resolve a problem of difficulty in replacing a peripheral component.

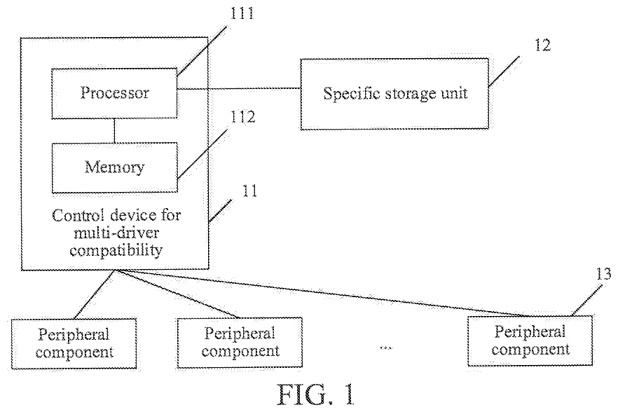

FIG. 1 is a schematic diagram of an application environment of a control device for multi-driver compatibility according to an embodiment of the present invention. In this embodiment, the control device 11 for multi-driver compatibility is connected to a specific storage unit 12 in a wired manner, and may be connected to one or more peripheral components 13 in a wired or wireless manner. The control device 11 for multi-driver compatibility may be built in any other electric device, and configured to perform compatibility control on a plurality of drivers of the peripheral components 13 of the electric device, and may alternatively be connected to the one or more peripheral components 13 directly as a separate electric control device, and then, perform compatibility control on the plurality of drivers of the peripheral component 13. The control device 11 for multi-driver compatibility according to this embodiment of the present invention may be applied to the foregoing main module.

The control device 11 for multi-driver compatibility according to this embodiment of the present invention includes: a memory 112, a processor 111 and a computer program stored on the memory 112 and executable on the processor 111, where when executed by the processor 111, the computer program implements the following steps:

obtaining identity information of a connected peripheral component 13;

reading, according to the identity information, configuration information corresponding to the peripheral component 13 pre-stored in a specific storage unit 12; and

loading a corresponding driver according to the configuration information.

In the embodiments of the present invention, compatibility with drivers of a plurality of peripheral components is achieved. Flexibility of replacing a component of a product is improved. A problem that a life cycle of a peripheral component is not synchronized with a life cycle of a main module is resolved. In addition, configuration information of a peripheral component is not limited by a hardware condition. Configuration is simple and flexible.

The processor 111 may be a central processing unit (CPU), or may be another general-purpose processor, a digital signal processor (DSP), an application-specific integrated circuit (ASIC), a field programmable gate array (FPGA) or another programmable logic device, a discrete gate or a transistor logic device, a discrete hardware component, or the like. The general-purpose processor may be a microprocessor, or the processor may be any common processor. The processor is a control center of the control device 11 for multi-driver compatibility, and is connected to all parts of the control device 11 for multi-driver compatibility through different interfaces and circuits.

The memory 112 may include at least one type of readable storage medium. The readable storage medium includes a flash memory, a hard disk drive, a multimedia card, a card-type memory (for example, an SD or a DX memory), a random access memory (RAM), a static random access memory (SRAM), a read-only memory (ROM), an electrically erasable programmable read-only memory (EEPROM), a programmable read-only memory (PROM), a magnetic memory, a magnetic disk, an optical disc, or the like.

In an implementation, the configuration information includes a number of the peripheral component 13 and corresponding version information.

In an implementation, the specific storage unit 12 is a separate storage module, or

a non-erasable area is set in the memory 112 as the specific storage unit.

When the specific storage unit 12 is a separate storage module, the specific storage unit 12 may be considered as a peripheral component.

When a non-erasable area is set in the memory 112 as the specific storage unit, the specific storage unit 12 is a part of the memory 112.

In an implementation, the specific storage unit 12 is an EEPROM.

In an implementation, when executed by the processor, the computer program implements the following steps:

obtaining identity information of the peripheral component 13 according to a type of an interface connected to the peripheral component 13; or

directly obtaining identity information of the peripheral component 13 preset in the specific storage unit 12.

The identity information of the peripheral component 13 may be a number, an identity or the like of the peripheral component.

In an implementation, when executed by the processor, the computer program implements the following step:

during replacement for a peripheral component 13 of a different version, resetting configuration information and/or identity information of the peripheral component 13 stored in the specific storage unit 12.

In an implementation, when executed by the processor, the computer program implements the following step:

when no configuration information corresponding to the peripheral component 13 is read or when the configuration information is wrong, loading a default driver.

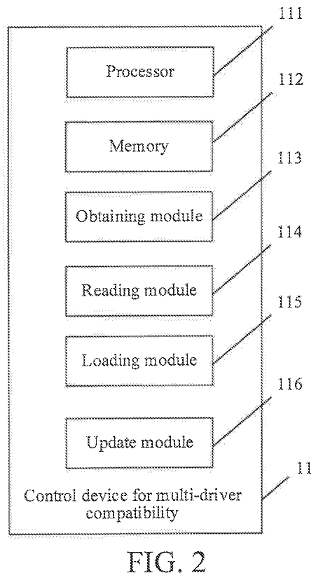

FIG. 2 is a schematic diagram of a functional module of a control device for multi-driver compatibility according to an embodiment of the present invention. In this embodiment, the control device for multi-driver compatibility includes an obtaining module 113, a reading module 114, a loading module 115, a memory 112 and a processor 111. The memory 25 and the processor 26 are stated above. Details are not described herein again.

The obtaining module 113 is configured to obtain identity information of a connected peripheral component.

The reading module 114 is configured to read, according to the identity information, configuration information corresponding to the peripheral component pre-stored in a specific storage unit.

The loading module 115 is configured to load a corresponding driver according to the configuration information.

In an implementation, the reading module 114 is further configured to:

obtain identity information of the peripheral component according to a type of an interface connected to the peripheral component; or

directly obtain identity information of the peripheral component preset in the specific storage unit.

A type of the connecting interface may be: a universal asynchronous receiver/transmitter (UART), an inter-integrated circuit (I2C) bus, a universal serial bus (USB) or the like.

In an implementation, the device further includes an update module 116, configured to: during replacement for a peripheral component of a different version, reset configuration information and/or identity information of the peripheral component stored in the specific storage unit.

In an implementation, the loading module 115 is further configured to:

when no configuration information corresponding to the peripheral component is read or when the configuration information is wrong, load a default driver.

In the embodiments of the present invention, compatibility with drivers of a plurality of peripheral components is achieved. Flexibility of replacing a component of a product is improved. A problem that a life cycle of a peripheral component is not synchronized with a life cycle of a main module is resolved. In addition, configuration information of a peripheral component is not limited by a hardware condition. Configuration is simple and flexible.

An example in which a specific storage unit 12 is a separate EEPROM is used for description below.

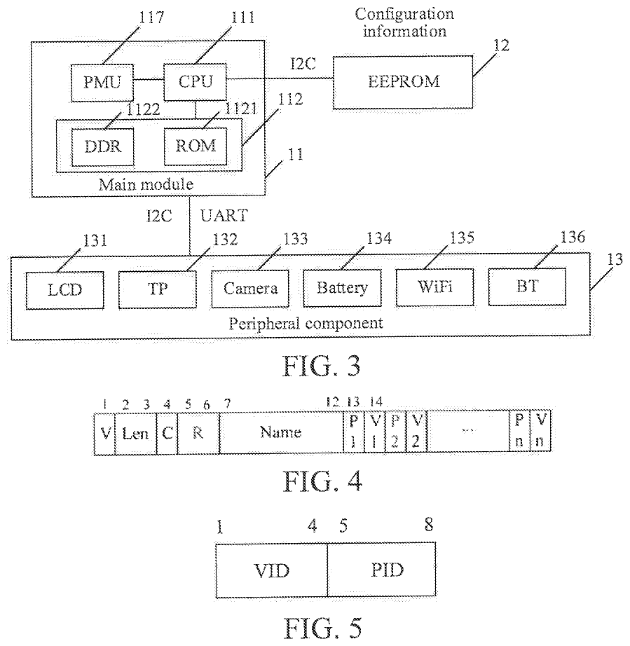

As shown in FIG. 3, a control device 11 for multi-driver compatibility is a main module, including a processor 111 (which is a CPU), a memory 112 and a PMU 113. The memory 112 includes a ROM 1121 and a DDR 1122. Peripheral components 13 include an LCD 131, a TP 132, a camera 133, a battery 134, a WiFi 135 and a BT 136. The main module 11 and the peripheral components 13 communicate through a bus such as a universal asynchronous receiver/transmitter (UART), an inter-integrated circuit (I2C) or a universal serial bus (USB).

In this application example, configuration management is performed on the peripheral components 13 in a centralized manner, configuration information including a component number corresponding to each peripheral component and corresponding version information. In terms of hardware design, an EEPROM 12 is added, and configured to store the configuration information of the peripheral components 13.

Because the EEPROM can store information after a power failure, each time when a system is powered up and starts, identity information of the connected peripheral components 13 is obtained. Configuration information of the peripheral components 13 is read from the EEPROM according to the identity information. Different types of drivers are loaded according to the configuration information. The configuration information in the EEPROM is configured differently according to peripheral components 13 used in different batches of products, and is solidified before delivery. If a component of a product needs to be replaced when the product is returned for repair, and a previously configured peripheral component is out of material, configuration information needs to be remade. After firmware in the EEPROM is refreshed, other materials compatible with the driver may be used for replacement.

The configuration information in the EEPROM 12 needs to be read before all drivers are loaded. In addition, a read time should be short as possible, to avoid affecting a start speed of the system. The EEPROM 12 and the main module 11 usually communicate through a serial peripheral interface (SPI), an I2C or a UART. Because a storage capacity of the EEPROM is not very large, the information stored in the EEPROM needs to be simplified as much as possible while having a volume as large as possible.

As shown in FIG. 4, a storage method is adopted, in which stored information is stored in an order of byte. First 12 bytes are an information header, and the rest are stored configuration information of a component. The stored header of 12 bytes includes the following:

V: version information of the EEPROM, in 1 byte;

Len: a length of data stored in the EEPROM, including the 12-byte information header, in 2 bytes;

C: a checksum of Len byte data stored in the EEPROM, the byte being calculated according to FF during check calculation, in 1 byte;

R: reserved information, in 2 bytes; and

Name: name of the product, in 6 bytes at most.

According to that every 2 bytes represent configuration information of a component, a first byte represents a number of the component, a second byte representing version information of the component. The version information may include a vendor identity and a product identity. One pair of information is stored for one component. Configuration information of 256 types of components may be represented at most, while is enough for use in most mobile terminal products.

For components, other than the main control chip, in the main module, for example, a ROM, an embedded multimedia card (eMMC) or a NAND flash memory is usually used in a mobile terminal currently. If pins are compatible during hardware design, different drivers may also be run according to dynamic configuration.

To ensure consistency between content of an EEPROM writing program and content of program parsing firmware of a mobile terminal, management on component information needs to be standardized correspondingly. Table 1 provides a design example of standardized component management.

TABLE 1
Standardized number management on some components

| Sequence | Component | Component | |
|---|---|---|---|
| number | name | number | Description |
| 1 | ROM | 0 | eMMC or NAND flash |
| | | | memory |
| 2 | DDR | 1 | Dynamic memory |
| 3 | Main LCD | 2 | Main display screen |
| 4 | Sub LCD | 3 | Subsidiary display |
| | | | screen |
| 5 | TP | 4 | Touch panel |
| 6 | Keyboard | 5 | Keyboard |
| 7 | Battery | 6 | Battery |
| 8 | PMU | 7 | Power management |
| | | | module |
| 9 | Rear Camera | 8 | Rear camera |
| 10 | Front Camera | 9 | Front camera |
| 11 | Flash Light | 10 | Flash light |
| 12 | Charger | 11 | Charger chip |
| 13 | Fuel Gauge | 12 | Electricity meter |
| 14 | WiFi | 13 | WiFi module |
| 15 | BT | 14 | Bluetooth module |
| 16 | Motor | 15 | Motor |
| 17 | Speaker | 16 | Speaker |
| 18 | Light-Sensor | 17 | Light sensor |
| 19 | G-Sensor | 18 | Gravity sensor |
| 20 | Acc-Sensor | 19 | Acceleration sensor |
| 21 | Mag-Sensor | 20 | Magnetic sensor |
| 22 | Ori-Sensor | 21 | Orientation sensor |
| 23 | Gyroscope | 22 | Gyroscope |
| 24 | P-Sensor | 23 | Pressure sensor |
| 25 | T-Sensor | 24 | Temperature sensor |
| 26 | H-Sensor | 25 | Humidity sensor |
| 27 | S-Sensor | 26 | Smoke sensor |
| 28 | R-Sensor | 27 | Infrared sensor |
| 29 | Proximity-Sensor | 28 | Range sensor |
| 30 | GPS | 29 | GPS module |
| 31 | FM | 30 | Radio module |
| 32 | TV | 31 | Television module |

Version information management on each component may be determined by each manufacturer according to its own design. As shown in FIG. 5, in an implementation, first 4 bits represent a vendor identity (vendor ID), last 4 bits representing a product identity (product ID). In this way, each component may be selected from 16 vendors, and each vendor may be compatible with 16 types of products.

It should be noted that, although an EEPROM is used as the specific storage unit in this application example, the present invention is not limited thereto. Provided that a storage medium can store configuration information, and is non-volatile, that is, does not lose information during a power failure, the storage medium can implement the embodiments of the present invention, and falls within the protection scope of the present invention.

It should be further noted that, storage formats in the EEPROM shown in FIG. 4 and FIG. 5 are only examples. The present invention is not limited thereto, and may adopt other formats according to requirements.

Moreover, in addition to being a connected in a manner such as an I2C, an SPI or a UART, the EEPROM and the main module may also be connected in another manner. Other peripheral components and the main module may be connected in connection manners other than the I2C and the UART. No specific limitation is imposed in the present invention.

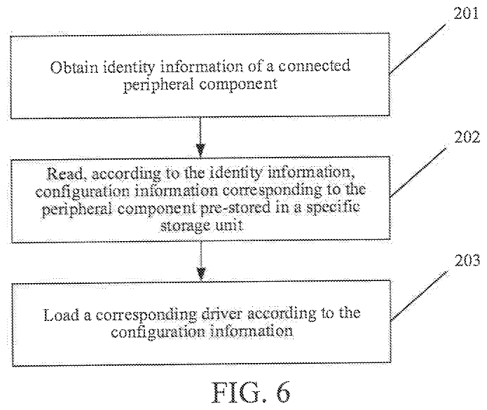

As shown in FIG. 6, an implementation method for multi-driver compatibility according to an embodiment of the present invention is applied to a control device for multi-driver compatibility including a processor and a memory, the control device for multi-driver compatibility being connected to one or more peripheral components, the method including the following steps:

Step 201. Obtain identity information of a connected peripheral component.

Step 202. Read, according to the identity information, configuration information corresponding to the peripheral component pre-stored in a specific storage unit.

Step 203. Load a corresponding driver according to the configuration information.

In an implementation, the configuration information includes a number of the peripheral component and corresponding version information.

In an implementation, the specific storage unit is a separate storage module, or

a non-erasable area is set in the memory as the specific storage unit.

In an implementation, the specific storage unit is an electrically erasable programmable read-only memory EEPROM.

In an implementation, the step of obtaining identity information of a connected peripheral component includes:

obtaining the identity information of the peripheral component according to a type of an interface connected to the peripheral component; or

directly obtaining the identity information of the peripheral component preset in the specific storage unit.

In an implementation, the method further includes:

during replacement for a peripheral component of a different version, resetting configuration information and/or identity information of the peripheral component stored in the specific storage unit.

In an implementation, the method further includes:

when no configuration information corresponding to the peripheral component is read or when the configuration information is wrong, loading a default driver.

In the embodiments of the present invention, compatibility with drivers of a plurality of peripheral components is achieved. Flexibility of replacing a component of a product is improved. A problem that a life cycle of a peripheral component is not synchronized with a life cycle of a main module is resolved. Configuration information of the peripheral component is not limited by hardware conditions. Configuration is simple and flexible. When a specific storage unit is an EEPROM, low costs, a large storage capacity, and high reliability are achieved. If no configuration information corresponding to the peripheral component is read or the configuration information is determined to be wrong, a default driver is loaded, thereby achieving compatibility with a case of no configuration information or wrong configuration information.

The present invention further provides a computer-readable storage medium, storing a computer-executable instruction, where the computer-executable instruction is configured to perform the foregoing implementation method for multi-driver compatibility.

The computer-readable storage medium includes a flash memory, a hard disk drive, a multimedia card, a card-type memory (for example, an SD or a DX memory), a random access memory (RAM), a static random access memory (SRAM), a read-only memory (ROM), an electrically erasable programmable read-only memory (EEPROM), a programmable read-only memory (PROM), a magnetic memory, a magnetic disk, an optical disc, or the like.

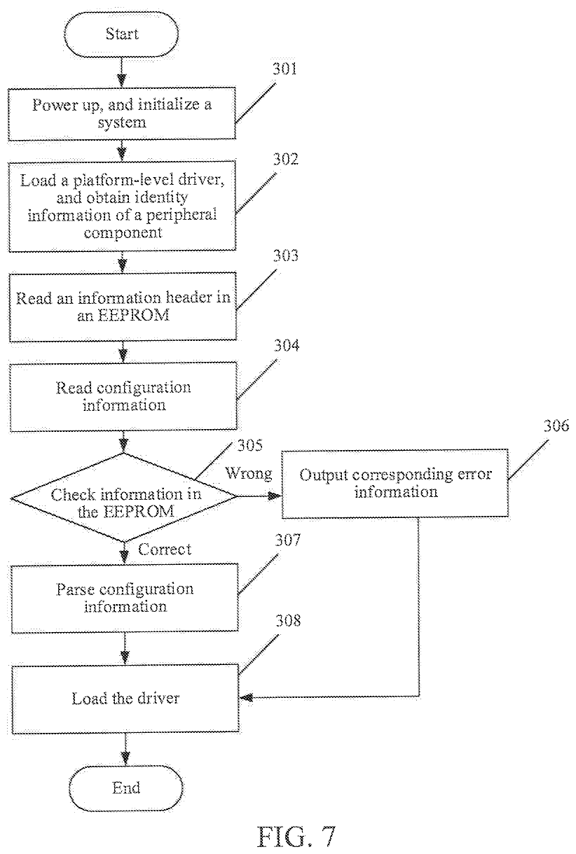

As shown in FIG. 7, with regard to adopting an EEPROM as a specific storage unit in FIG. 3, a software flowchart of an implementation method for multi-driver compatibility includes the following steps:

Step 301. Power up a machine, and initialize a basic system including a CPU, a DDR, a PMU, a clock, an interrupter, and the like.

Step 302. Load a platform-level driver such as an I2C, a UART and an SPI, and obtain identity information of the peripheral component according to a type of a connection interface.

Step 303. Read an information header in an EEPROM.

Step 304. Read configuration information corresponding to the peripheral component according to a length and identity information of the peripheral component in the EEPROM.

Step 305. Check whether information in the EEPROM is correct, perform step 306 if the information is incorrect, and perform step 307 if the information is correct.

Step 306. Output a corresponding error log, and perform step 308.

Step 307. Parse configuration information.

Step 308. Load a driver of the peripheral component, and load a corresponding driver if the peripheral component has configuration information; otherwise, load a default driver.

The foregoing software running environment may include Linux, Windows or another embedded system.

For an example in this embodiment, refer to the examples described in the foregoing embodiments and implementations. Details are not described again in this embodiment.

Apparently, a person skilled in the art should understand that the modules or steps in the embodiments of the present invention may be implemented by using a general-purpose computing device, and may be centralized on a single computing device or distributed on a network including a plurality of computing devices. Optionally, they may be implemented by program code executable on a computing device, so that they can be stored in a storage device and executed by a computing device. In addition, in some cases, the steps shown or described may be performed in an order different from the order herein. Alternatively, they are separately manufactured into integrated circuit modules, or a plurality of modules or steps in them are manufactured into a single integrated circuit module for implementation. The embodiments of the present invention are not limited to any specific combination of hardware and software.

Although implementations disclosed in the present invention are stated above, the described contents are merely implementations adopted to help understand the present invention, and are not intended to limit the present invention. Any person skilled in the art of the present invention can make any modifications and variations to forms and details of implementation without departing from the spirit and scope disclosed in the present invention. However, the protection scope of the present invention is subject to the scope defined the appended claims.

What is claimed is:

1. A control device for multi-driver compatibility, comprising: a memory, a processor and a computer program stored on the memory and executable on the processor, wherein when executed by the processor, the computer program implements the following steps:
obtaining identity information of a connected peripheral component;
reading, according to the identity information, configuration information corresponding to the peripheral component pre-stored in a specific storage unit; and
loading a corresponding driver according to the configuration information.

2. The device according to claim 1, wherein
the configuration information comprises a number of the peripheral component and corresponding version information.

3. The device according to claim 1, wherein
the specific storage unit is a separate storage module, or
a non-erasable area is set in the memory as the specific storage unit.

4. The device according to claim 1, wherein
the specific storage unit is an electrically erasable programmable read-only memory EEPROM.

5. The device according to claim 1, wherein when executed by the processor, the computer program implements the following step:
obtaining the identity information of the peripheral component according to a type of an interface connected to the peripheral component; or
directly obtaining the identity information of the peripheral component preset in the specific storage unit.

6. The device according to claim 1, wherein when executed by the processor, the computer program implements the following step:
during replacement for a peripheral component of a different version, resetting configuration information and/or identity information of the peripheral component stored in the specific storage unit.

7. The device according to claim 1, wherein when executed by the processor, the computer program implements the following step:
when no configuration information corresponding to the peripheral component is read or when the configuration information is wrong, loading a default driver.

8. An implementation method for multi-driver compatibility, applied to a control device for multi-driver compatibility comprising a processor and a memory, the control device for multi-driver compatibility being connected to one or more peripheral components, the method comprising:
obtaining identity information of a connected peripheral component;
reading, according to the identity information, configuration information corresponding to the peripheral component pre-stored in a specific storage unit; and
loading a corresponding driver according to the configuration information.

9. The method according to claim 8, wherein
the configuration information comprises a number of the peripheral component and corresponding version information.

10. The method according to claim 8, wherein
the specific storage unit is a separate storage module, or
a non-erasable area is set in the memory as the specific storage unit.

11. The method according to claim 8, wherein
the specific storage unit is an electrically erasable programmable read-only memory EEPROM.

12. The method according to claim 8, wherein the obtaining identity information of a connected peripheral component comprises:
obtaining the identity information of the peripheral component according to a type of an interface connected to the peripheral component; or
directly obtaining the identity information of the peripheral component preset in the specific storage unit.

13. The method according to claim 8, wherein the method further comprises:
during replacement for a peripheral component of a different version, resetting configuration information and/or identity information of the peripheral component stored in the specific storage unit.

14. The method according to claim 8, wherein the method further comprises:
when no configuration information corresponding to the peripheral component is read or when the configuration information is wrong, loading a default driver.

15. A computer-readable storage medium, storing a computer-executable instruction, wherein the computer-executable instruction is configured to perform the implementation method for multi-driver compatibility according to claim 8.
